(19) United States
(12) Patent Application Publication
(10) Pub. No.: US 2025/0245500 A1
(43) Pub. Date: Jul. 31, 2025

(54) METHOD AND APPARATUS FOR OPTIMIZING OUT-OF-DISTRIBUTION (OOD) DETECTION

(71) Applicant: Robert Bosch GmbH, Stuttgart (DE)

(72) Inventors: Deepthi Sreenivasaiah, Erlangen (DE); Joseph Trotta, Adelfia (Bari) (IT); Clint Sebastian, Stuttgart (DE)

(21) Appl. No.: 19/026,787

(22) Filed: Jan. 17, 2025

(30) Foreign Application Priority Data
Jan. 31, 2024 (DE) 10 2024 200 871.0

(51) Int. Cl. G06N 3/08; G06N 3/045

(52) U.S. Cl. CPC G06N 3/08; G06N 3/045

(57) ABSTRACT

A method and an apparatus for optimizing out-of-distribution (OOD) detection using a k-nearest neighbors (KNN) method in an ensemble model with a plurality of artificial neural networks. The method includes: providing an adapted KNN detector for each of the plurality of artificial neural networks; calculating a feature vector on the basis of test or inference data for each of the plurality of artificial neural networks; providing the calculated feature vector in each case to the correspondingly adapted KNN detector; ascertaining a relevant OOD score by means of the correspondingly adapted KNN detector on the basis of the feature vector provided in each case; and averaging the ascertained OOD scores for optimized OOD detection using the KNN method.

### CROSS REFERENCE

The present application claims the benefit under 35 U.S.C. § 119 of German Patent Application No. 10 2024 200 871.0 filed on Jan. 31, 2024, which is expressly incorporated herein by reference in its entirety.

### FIELD

The present invention relates to two alternative methods and two alternative apparatuses for optimizing out-of-distribution (OOD) detection using a k-nearest neighbors (KNN) method in an ensemble model with a plurality of artificial neural networks. The present invention additionally relates to a control device for carrying out such a method. The present invention further relates to a computer program and to a computer-readable data carrier.

### BACKGROUND INFORMATION

A concern of artificial intelligence and in particular machine learning is the ability of models to correctly classify data and make predictions. In this context, the question arises as to how well or accurately a model is able to detect data that differ greatly from the data on which it was trained. This problem, known as “out-of-distribution” (OOD) detection, has gained increasing importance in recent years.

OOD detection refers to the task of identifying samples or data points that lie outside a distribution of training data. These samples are anomalous or lie outside the distribution, i.e., they differ, possibly significantly, from the (training) data on the basis of which the model was trained. Detecting OOD is critical to the robustness and reliability of machine learning models because it helps identify situations where the model's predictions might be unreliable or erroneous.

To effectively handle OOD detection, different approaches have been developed, which can be divided into three main categories: post-hoc inference methods, training methods with OOD data, and training methods without OOD data. Post-hoc inference methods are only effective during the inference phase and use pre-trained networks to generate an OOD score. In contrast, training methods with OOD data require retraining the model using OOD data, while training methods without OOD data execute model retraining without specific OOD data.

Recently, a comprehensive review and benchmark of OOD detection methods was proposed, showing how these different approaches perform. This showed that post-hoc inference methods in particular are efficient in most cases and even perform better than their competitors that rely on retraining and OOD data. A remarkably simple yet effective approach is the k-nearest neighbors (KNN) method, which uses a non-parametric distance between the nearest neighbors and the feature vectors of the training data to detect OOD data.

While KNN is a powerful technique that offers high performance, it is difficult to use ensemble models because the feature vectors used in KNN methods can have different sizes and often cannot be combined meaningfully or efficiently.

Thus, there is still room for improvement in the field of ensemble models, which are used, for example, in manufacturing to achieve generalization and better performance.

An object of the present invention is to provide at least one method and/or at least one apparatus for optimizing out-of-distribution (OOD) detection using a k-nearest neighbors (KNN) method in an ensemble model with a plurality of artificial neural networks.

The object may be achieved by a method having certain features of the present invention. The object may be achieved by an alternative method according to present invention. The object may be achieved by an apparatus according to the present invention. The object may be achieved by an alternative apparatus according to the present invention. The object may also be achieved by a control device for executing such a method, according to the present invention. Furthermore, the object may be achieved by a computer program and a computer-readable data carrier according to the present invention.

According to a first aspect of the present invention, a method for optimizing out-of-distribution (OOD) detection using a k-nearest neighbors (KNN) method in an ensemble model with a plurality of artificial neural networks is proposed. According to an example embodiment of the present invention, the method for optimizing comprises the following steps:
providing an adapted KNN detector for each of the plurality of artificial neural networks;
calculating a feature vector on the basis of test or inference data for each of the plurality of artificial neural networks;
providing, in particular inputting, the calculated feature vector in each case to the correspondingly adapted KNN detector;
ascertaining a relevant OOD score by means of the correspondingly adapted KNN detector on the basis of the feature vector provided in each case; and
averaging the ascertained OOD scores for optimized OOD detection using the KNN method.

“K-nearest neighbors” (k-NN or KNN) describes a machine learning algorithm. This algorithm is based on the idea that similar data points in a feature space tend to have the same class or the same value. The k-NN algorithm works with a data set made up of data points. Each data point is described by a series of features. The “k” in k-NN represents a positive integer and is an important hyperparameter. It must be specified how many neighbors are to be considered. To find the k nearest neighbors for a given data point, the distance between that data point and all other data points in the dataset is calculated. The Euclidean distance is used for this, but there are also other distance metrics that can be used depending on the case of application. After calculating the distances, the k data points are selected that have the smallest distances to the given data point. These are the “k nearest neighbors.” For classification, the majority of classes among the k nearest neighbors is determined and the given data point is assigned to this class. For regression, the average or a weighted average of the values of the k nearest neighbors is calculated to obtain an estimated value for the given data point. After the algorithm has been trained, predictions can be made for new data points by repeating the above steps.

An “ensemble model” describes a machine learning model that has at least two or more than two models, for example artificial neural networks. Such ensemble models are used to solve more complex tasks. The individual models or networks can be linked to each other on the input or output side. The individual models or networks can be trained on the same or possibly different training data.

A “KNN detector” indicates that the k-NN algorithm is used for anomaly detection or data classification. For example, a KNN detector can be used to identify unusual patterns or outliers in data. This means that the k-NN algorithm is applied to evaluate the similarity of data points in a feature space and to detect deviations from the expected patterns.

A “feature vector” describes a representation of a data point in a feature space. A feature vector is made up of an ordered list of numerical values that represent the different features or properties of the data point. These features are important pieces of information that can be used to characterize or describe the data point.

An “OOD score” or OOD value stands for “out-of-distribution score/value” and is a measure of how well a machine learning model has the ability to detect or identify data points or inputs that are outside the distribution or range of the training data. In many machine learning or classification tasks, a model is trained to assign data points to certain classes or categories based on the features or properties of those data points. The model may perform well when faced with data points that lie within its training data distribution, but it may have difficulty when faced with data points that are “out of distribution,” that is, that differ greatly from the training data. The OOD score is a way to quantify the uncertainty or confidence of a model in predicting data points outside of its training data. A low OOD score indicates that the model tends to classify data points as “in-distribution” even when they are actually “out of distribution,” which can pose a risk of misclassification. A high OOD score, on the other hand, indicates that the model detects when it encounters data that do not match the training data and is uncertain or cautious in its prediction.

“Averaging the ascertained OOD scores for optimized OOD detection using the KNN method” is understood as forming an average of the ascertained OOD scores for optimized OOD detection.

The test or inference data can, for example, be a test pattern or inference pattern for which the relevant feature vector is calculated for each artificial neural network and, if necessary, normalized.

In this case, an adaptation of the KNN algorithm is thus carried out. This refines the KNN algorithm so that it can preferably be used better in fields in which ensemble models are used. This adaptation is advantageous because KNN, although extremely efficient for OOD, is not directly applicable when ensemble models are used. Two different possible adaptations are proposed here. These are reflected in the methods according to the first and second aspects and in the corresponding embodiments. In both cases, it is preferable to provide an adapted KNN detector for each network in the ensemble model. This adaptation is preferably carried out in the training phase of the ensemble model. The adaptation of a KNN detector preferably means that the feature vectors are collected from each model or artificial neural network.

According to the first aspect of the present invention, the OOD scores of the individual KNN detectors are preferably averaged. This is more robust than a single OOD score because KNN (and the other post-hoc inference methods) are based on the underlying pre-trained network in each case. In the method according to the first aspect, the individual artificial neural networks that are part of the ensemble model are preferably trained such that the feature vectors can be retrieved in a simple manner.

The method according to the present invention is more robust because it combines the point values of the features or feature vectors from a plurality of models or artificial neural networks. This also reduces the risk of overfitting and improves the performance of the ensemble model (also in terms of generalization), making the method of the present invention more suitable for handling different data sets.

In one example embodiment of the present invention, providing the adapted KNN detector for each of the plurality of artificial networks comprises:
during a training phase of the ensemble model on the basis of training data,
   extracting and/or collecting feature vectors of the training data from each of the plurality of artificial neural networks; and
   adapting a KNN detector for each of the plurality of artificial neural networks on the basis of the extracted feature vectors.

In this case, adapting a KNN detector thus means only the collection of the training feature vectors in the training phase of the ensemble model.

In one embodiment of the present invention, calculating the feature vector on the basis of the test or inference data for each of the plurality of artificial neural networks comprises:
normalizing the feature vector calculated for each of the plurality of artificial neural networks.

“Normalizing the feature vector calculated for each of the plurality of artificial neural networks” refers to a step in the pre-processing of data that is used to bring the feature vectors calculated by different neural networks into a uniform or comparable form. A feature vector is a representation of a data point in a feature space. It is made up of numerical values that represent the different features or properties of the data point. Artificial neural networks are machine learning models that are made up of a hierarchy of artificial neurons and are used for pattern recognition, classification, and regression. Each neural network can calculate feature vectors for input data. Normalizing feature vectors often involves adapting the values in the vectors to ensure that they have a particular scale or distribution. This can help ensure that the feature vectors are comparable and the models can be better trained or compared.

Normalization ensures that the feature vectors from different neural networks are in a uniform form. This means that they may have the same average, standard deviation, or range of values, so they can be combined or compared. Normalizing feature vectors can help models perform more robustly and efficiently, in particular when the feature vectors originate from different sources and have different scales or distributions. This can also be useful in ensembles of neural networks in which the outputs of a plurality of models are combined to produce better predictions. The exact method of normalization may vary depending on the specific requirements and properties of the data.

In one example embodiment of the present invention, the ascertained OOD scores are weighted prior to averaging on the basis of a performance of the relevant artificial neural network and/or on the basis of a performance of the relevant adapted KNN detector.

For example, if an artificial neural network of the plurality of networks of the ensemble model has a higher power or better performance compared to one or more other networks, this network is assigned a higher weight compared to the other network(s). For example, if an adapted KNN detector of the plurality of KNN detectors has a higher power or better performance compared to one or more other KNN detectors, this KNN detector is assigned a higher weight compared to the other KNN detector(s).

According to a second aspect of the present invention, a method for optimizing out-of-distribution (OOD) detection using a k-nearest neighbors (KNN) method in an ensemble model with a plurality of artificial neural networks is provided.

According to an example embodiment of the present invention, the method for optimizing comprises the steps of:
providing an adapted KNN detector of the ensemble model;
calculating a feature vector on the basis of test or inference data for each of the plurality of artificial neural networks;
executing a PCA for each of the calculated feature vectors in order to obtain unidimensional feature vectors in each case;
averaging the unidimensional calculated feature vectors to obtain an averaged feature vector; and
calculating an OOD score on the basis of the averaged feature vector by means of the adapted KNN detector.

The terms defined above apply accordingly to the method according to the second aspect, and vice versa.

Principal component analysis (PCA) is a statistical method used to detect and visualize the structure of complex data. It is used to reduce the dimensions of the data without losing important information. PCA is used to transform data into a smaller set of new variables, called principal components, which may have a larger variance than the original variables. The PCA therefore uses a number of features to be analyzed that is smaller than the number of features to be originally examined in order to obtain residuals that enable a statement to be made about an anomaly in the semiconductor component to be examined. An inverse PCA may be used to reconstruct data. It is then ascertained whether and where reconstruction errors are particularly high in relation to the initial data in order to draw conclusions about an anomaly.

“Unidimensional feature vectors” are feature vectors that have the same number of dimensions in a multidimensional vector space.

The test or inference data can, for example, be a test pattern or inference pattern for which the relevant feature vector is calculated for each artificial neural network and, if necessary, normalized.

According to the second aspect of the present invention, applying PCA with a predefined number of components to each feature vector is provided. Furthermore, an average of the feature vectors calculated by each artificial neural network according to the PCA is ascertained. Subsequently, the previously adapted KNN detectors are preferably applied using this average. In the method according to the second aspect, the individual artificial neural networks that are part of the ensemble model are preferably trained such that the feature vectors can be retrieved in a simple manner.

The method according to the second aspect of the present invention is more robust because it summarizes the point values of the features or feature vectors from a plurality of models or artificial neural networks. This also reduces the risk of overfitting and improves the performance of the ensemble model (also in terms of generalization), making the proposed method more suitable for handling different data sets.

In one example embodiment of the present invention, providing the adapted KNN detector of the ensemble model comprises: during a training phase of the ensemble model on the basis of training data,
extracting and/or collecting feature vectors of the training data from each of the plurality of artificial neural networks;
executing a PCA for each of the plurality of artificial neural networks on the basis of the extracted feature vectors in order to obtain unidimensional feature vectors in each case;
averaging the unidimensional feature vectors; and
adapting a standard KNN detector of the ensemble model on the basis of the averaged feature vector.

A “standard KNN detector” describes an unadapted KNN detector as it can be used in an ensemble model for the networks contained therein. Only one KNN detector, or a plurality of KNN detectors, can be used, for example one KNN detector per network.

In one example embodiment of the present invention, calculating the feature vector on the basis of the test or inference data for each of the plurality of artificial neural networks comprises:
normalizing the feature vector calculated for each of the plurality of artificial neural networks.

In one example embodiment of the present invention, the relevant PCA is executed with a predefined number of components.

PCA (Principal Component Analysis) aims to reduce the dimensionality of a data set while retaining as much of the variance of the data set as possible. The embodiment describes a specific implementation of the PCA in which the number of principal components extracted from the original data is specified in advance. These are the components that explain most of the variance in the data. The predefined number is preferably a parameter that is set before executing the PCA, for example based on criteria such as explanation of variance, computational complexity, and/or other specific requirements of the case of application.

In one example embodiment of the present invention, the predefined number of components is chosen on the basis of hyperparameters of the plurality of artificial neural networks.

“Hyperparameters” are preferably understood here to mean settings or configurations that are not learned from the data themselves, but must be specified before the model training. They influence how the model or network is trained and can significantly affect the performance and behavior of the model.

In one example embodiment of the present invention, the number of components is less than the smallest feature vector of each of the plurality of artificial neural networks.

This is advantageous because the slimming of the feature space achieved by the PCA also applies to the feature vector that has the smallest number of dimensions.

In one example embodiment of the present invention, the method comprises the steps of: optimized OOD detection using the KNN method on the basis of the averaged OOD score, and identifying samples in training and/or inference data of an automated function and/or driving function of a motor vehicle and/or a drone and/or a robot that in particular deviate significantly from a training and/or inference distribution in the context.

In one example embodiment of the present invention, the method further comprises the steps of: optimized OOD detection using the KNN method on the basis of the averaged OOD score, and detecting scenarios in training and/or inference data that lead to incorrect predictions by the ensemble model in order to avoid the occurrence of such scenarios.

For example, once one or more images (depending on the case of application) in training and/or inference data are detected as OOD and, in particular, confirmed as such by an expert, different strategies can be applied, such as retraining by incorporating the newly detected class of images or checking whether the outlier originates from a problem in the production lines.

In one example embodiment of the present invention, the method further comprises the steps of: optimized OOD detection using the KNN method on the basis of the averaged OOD score, and filtering training and/or inference data detected as OOD in order to reduce a number of warnings for an OOD case.

Such outliers can for example come from the ensemble model, which does not know the new outliers. This makes it easier for a person skilled in the art to identify where the problem that is causing the outliers may come from.

It is understood that the steps named above, as well as other optional steps, do not necessarily have to be executed in the order shown, but can also be executed in a different order. Other intermediate steps can also be provided. The individual steps can also comprise one or more sub-steps without departing from the scope of the method according to the present invention.

According to a third aspect of the present invention, an apparatus for optimizing out-of-distribution (OOD) detection using a k-nearest neighbors (KNN) method in an ensemble model with a plurality of artificial neural networks is provided. According to an example embodiment of the present invention, the apparatus for optimizing has an evaluation and computing device which is configured to execute the following steps:
providing an adapted KNN detector for each of the plurality of artificial neural networks;
calculating a feature vector on the basis of test or inference data for each of the plurality of artificial neural networks;
providing, in particular inputting, the calculated feature vector in each case to the correspondingly adapted KNN detector;
ascertaining a relevant OOD score by means of the correspondingly adapted KNN detector on the basis of the feature vector provided in each case; and
averaging the ascertained OOD scores for optimized OOD detection using the KNN method.

According to a fourth aspect of the present invention, an apparatus for optimizing out-of-distribution (OOD) detection using a k-nearest neighbors (KNN) method in an ensemble model with a plurality of artificial neural networks is provided. According to an example embodiment of the present invention, the apparatus for optimizing has an evaluation and computing device which is configured to execute the following steps:
during a training phase of the ensemble model on the basis of training data,
   extracting feature vectors of the training data from each of the plurality of artificial neural networks;
   executing a PCA for each of the plurality of artificial neural networks on the basis of the extracted feature vectors in order to obtain unidimensional feature vectors in each case;
   averaging the unidimensional feature vectors; and
   adapting a standard KNN detector of the ensemble model on the basis of the averaged feature vector.

The explanations given for the method apply accordingly to the apparatuses, and vice versa. It is understood that linguistic modifications of features formulated for the method can be reformulated for the system in accordance with standard linguistic practice, without such formulations having to be explicitly listed here.

Also provided according to the present invention is a control device which is comprised for a semi-automated or automated driving function of a motor vehicle and/or of a drone and/or in a robotic system and/or in an industrial machine and/or is used for optical inspection, and on which a method of the present invention in one of its embodiments is executable.

The methods of the present invention described herein are preferably applied in various fields and scenarios where the ability to identify samples that deviate significantly from the training distribution is important. Examples include at least partially self-driving vehicles and/or drones and/or robotic systems. Furthermore, the application of the provided methods of the present invention in the field of automatic optical inspection (AOI) has proven promising to avoid and/or detect unusual scenarios that could lead to incorrect predictions. Once one or more images (depending on the case of application) are optimized according to the present method, detected as OOD and confirmed by domain experts, different strategies can be applied, such as retraining by incorporating the newly detected image class and/or checking whether the outlier originates from a problem in production lines.

Furthermore, the solution provided herein according to the present invention, in its two alternatives, can be used as a filter to reduce the number of warnings that come from an ML model that does not correctly detect occurring outliers, making it easier for the person skilled in the art to identify where a particular problem comes from.

An implementation of the method of the present invention in one of its embodiments in an AOI auto modeling toolbox can also be advantageous. This can improve the performance of the AOI auto modeling toolbox.

The present invention also provides a computer program having program code to execute at least parts of the present method in one of its embodiments when the computer program is executed on a computer. In other words, a computer program (product), comprising commands that, when the program is executed by a computer, cause the computer to execute the method/steps of the method of the present invention in one of its embodiments, is described.

The present invention also provides a computer-readable data carrier having program code of a computer program to execute at least parts of the method according to the present invention in one of its embodiments when the computer program is executed on a computer. In other words, the present invention relates to a computer-readable (storage) medium comprising commands that, when executed by a computer, cause the computer to execute the method/the steps of the method in one of its embodiments.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the example embodiments of the present invention. They illustrate example embodiments and, in connection with the description, serve to explain principles and concepts of the present invention.

Other embodiments of the present invention and many of the mentioned advantages are apparent from the figures. The illustrated elements of the figures are not necessarily shown to scale relative to one another.

FIG. 1 shows a schematic flow chart of a method according to the first aspect of the present invention.

FIG. 2 shows a schematic flowchart of a method according to the second aspect of the present invention

FIG. 3 shows a schematic block diagram of a training phase of an example embodiment of the method according to the first aspect of the present invention.

FIG. 4 shows a schematic block diagram of a test or inference phase of an example embodiment of the method according to the first aspect of the present invention.

FIG. 5 shows a schematic block diagram of a training phase of an example embodiment of the method according to the second aspect of the present invention.

FIG. 6 shows a schematic block diagram of a test or inference phase of an example embodiment of the method according to the second aspect of the present invention.

### DETAILED DESCRIPTION OF EXAMPLE EMBODIMENTS

In the figures, identical reference signs denote identical or functionally identical elements, parts or components, unless stated otherwise.

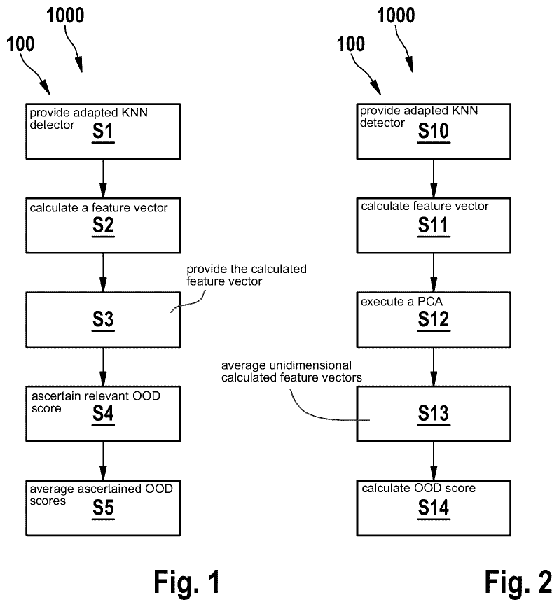

FIG. 1 shows a schematic flow diagram of a method according to the first aspect for optimizing out-of-distribution (OOD) detection using a k-nearest neighbors (KNN) method in an ensemble model with a plurality of artificial neural networks.

FIG. 2 shows a schematic flow diagram of a method according to the second aspect for optimizing out-of-distribution (OOD) detection using a k-nearest neighbors (KNN) method in an ensemble model with a plurality of artificial neural networks.

In any embodiment, the method according to the first or the second aspect can be executed at least partially by an apparatus 100 that can comprise, for this purpose, a plurality of components (not shown in more detail), for example one or more provisioning devices and/or at least one evaluation and computing device. It is self-evident that the provisioning device can be designed together with the evaluation and computing device, or can be different therefrom. Furthermore, the system can comprise a storage device and/or an output device and/or a display device and/or an input device.

The computer-implemented method according to the first aspect shown schematically in FIG. 1 comprises at least the following steps:

In a step S1, an adapted KNN detector is provided for each of the plurality of artificial neural networks.

In a step S2, a feature vector is calculated on the basis of test or inference data for each of the plurality of artificial neural networks.

In a step S3, the calculated feature vector is provided, in particular input, to the correspondingly adapted KNN detector.

In a step S4, a relevant OOD score is ascertained by means of the correspondingly adapted KNN detector on the basis of the feature vector provided in each case.

In a step S5, the ascertained OOD scores for optimized OOD detection are averaged using the KNN method.

The computer-implemented method according to the second aspect shown schematically in FIG. 2 comprises at least the following steps:

In a step S10, an adapted KNN detector of the ensemble model is provided.

In a step S11, a feature vector is calculated on the basis of test or inference data for each of the plurality of artificial neural networks.

In a step S12, a PCA is executed for each of the calculated feature vectors in order to obtain unidimensional feature vectors in each case.

In a step S13, the unidimensional calculated feature vectors are averaged to obtain an averaged feature vector.

In a step S14, an OOD score is calculated on the basis of the averaged feature vector by means of the adapted KNN detector.

The method according to the first or second aspect can also be executed on a control device 1000, as schematically indicated in FIGS. 1 and 2.

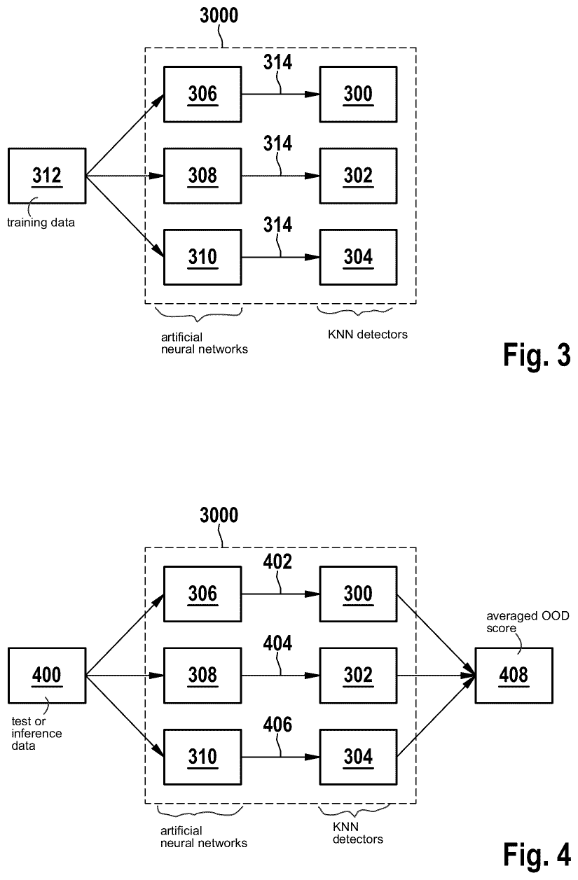

The block diagrams shown in FIG. 3-6 assume, purely by way of example, an ensemble model that has three models or artificial neural networks. Of course, other embodiments may also include ensemble models with more or fewer than three models or artificial neural networks.

FIG. 3 shows a detail of an embodiment of the present method according to the first aspect as a block diagram. Here it is shown in more detail how the provision S1 of the adapted KNN detector is carried out for each of the plurality of artificial neural networks. The adaptation or fitting of the KNN detectors 300, 302, 304 of the plurality of artificial neural networks 306, 308, 310 takes place during a training phase of the ensemble model 3000 on the basis of training data 312. This involves extracting feature vectors 314 of the training data 312 from each of the plurality of artificial neural networks 306, 308, 310 and adapting the relevant KNN detector 300, 302, 304 for each of the plurality of artificial neural networks 306, 308, 310 on the basis of the extracted feature vectors 314.

FIG. 4 shows a detail of an embodiment of the present method according to the first aspect as a block diagram. Here it is shown how, on the basis of test or inference data 400, a feature vector 402, 404, 406 is calculated for each of the plurality of artificial neural networks 306, 308, 310. The calculated feature vectors 402, 404, 406 are provided to the correspondingly adapted KNN detector 300, 302, 304 and a relevant OOD score is ascertained by means of the correspondingly adapted KNN detector 300, 302, 304 on the basis of the feature vector 402, 404, 406 provided in each case. The calculated or ascertained OOD scores are averaged to form an averaged OOD score 408 in order to enable optimized OOD detection using the KNN method.

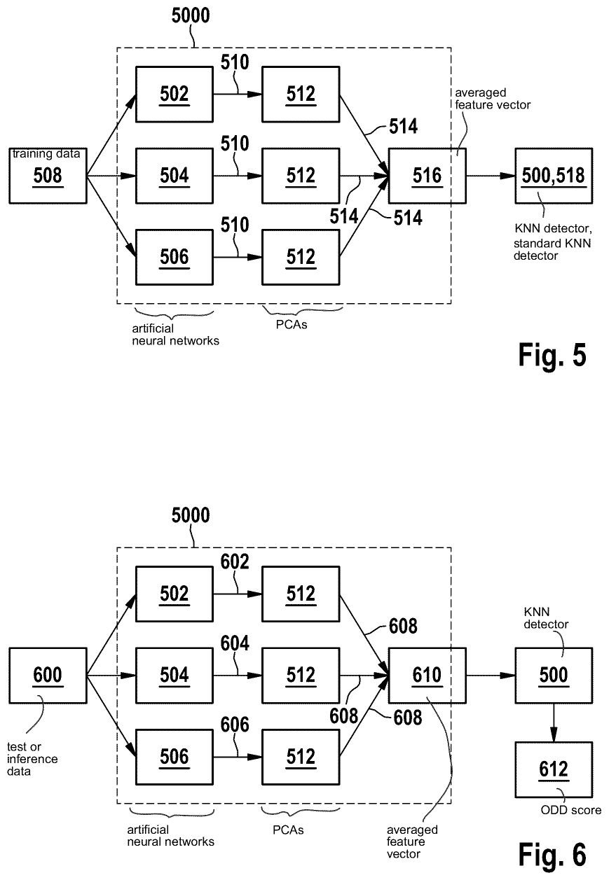

FIG. 5 shows a detail of an embodiment of the present method according to the second aspect as a block diagram. Here it is shown in more detail how the provision S10 of the adapted KNN detector is carried out for each of the plurality of artificial neural networks. The adaptation or fitting of the KNN detector 500 of the plurality of artificial neural networks 502, 504, 506 takes place during a training phase of the ensemble model 5000 on the basis of training data 508. This involves extracting feature vectors 510 of the training data 412 from each of the plurality of artificial neural networks 506, 508, 510 and executing a PCA 512 for each of the plurality of artificial neural networks 502, 504, 506 on the basis of the extracted feature vectors 510 in order to obtain unidimensional feature vectors 514 in each case. The unidimensional feature vectors are averaged to form an averaged unidirectional feature vector 516. Subsequently, a standard KNN detector 518 of the ensemble model 5000 is adapted on the basis of the averaged feature vector 516.

FIG. 6 shows a detail of an embodiment of the present method according to the second aspect as a block diagram. Here it is shown how, on the basis of test or inference data 600, a feature vector 602, 604, 606 is calculated for each of the plurality of artificial neural networks 502, 504, 506. A PCA 512 is executed for each of the calculated feature vectors 602, 604, 606 in order to obtain unidimensional feature vectors 608 in each case. The unidimensional calculated feature vectors 608 are averaged to obtain an averaged feature vector 610. Furthermore, a (common) OOD score 612 is ascertained on the basis of the averaged feature vector 610 by means of the adapted KNN detector 500.

What is claimed is:

1. A method for optimizing out-of-distribution (OOD) detection using a k-nearest neighbors (KNN) method in an ensemble model with a plurality of artificial neural networks, the method for optimizing comprising the following steps:
providing an adapted KNN detector for each of the plurality of artificial neural networks;
calculating a feature vector based on test or inference data, for each of the plurality of artificial neural networks;
providing the calculated feature vector of each artificial neural network to the adapted KNN detector of the artificial neural network;
ascertaining respective OOD scores using the adapted KNN detector of each artificial neural networked based of the feature vector for the artificial neural network; and
averaging the ascertained OOD scores for optimized OOD detection using the KNN method.

2. The method according to claim 1, wherein the providing of the adapted KNN detector for each of the plurality of artificial neural networks includes:
during a training phase of the ensemble model based on training data:
extracting feature vectors of the training data from each of the plurality of artificial neural networks, and
adapting the KNN detector for each of the plurality of artificial neural networks based on the extracted feature vectors.

3. The method according to claim 1, wherein the calculating of the feature vector based on the test or inference data for each of the plurality of artificial neural networks includes:
normalizing the feature vector calculated for each of the plurality of artificial neural networks.

4. The method according to claim 1, wherein the ascertained OOD score of each of the artifical neural networks is weighted before averaging based on a performance of the artificial neural network and/or based on a performance of the adapted KNN detector of the artificial neural network.

5. A method for optimizing out-of-distribution (OOD) detection using a k-nearest neighbors (KNN) method in an ensemble model with a plurality of artificial neural networks, the method for optimizing comprising the following steps:
providing an adapted KNN detector of the ensemble model;
calculating a respective feature vector for each of the plurality artificial nueural network based on the test or inference data for each of the plurality of artificial neural networks;
executing a PCA for each of the calculated feature vectors to obtain unidimensional feature vectors in each case;
averaging the unidimensional calculated feature vectors to obtain an averaged feature vector; and
calculating an OOD score based on the averaged feature vector using the adapted KNN detector.

6. The method according to claim 5, wherein the providing of the adapted KNN detector of the ensemble model includes:
during a training phase of the ensemble model based on training data:
extracting feature vectors of the training data from each of the plurality of artificial neural networks;
executing a PCA for each of the plurality of artificial neural networks based on the extracted feature vectors in order to obtain unidimensional feature vectors in each case;
averaging the unidimensional feature vectors; and
adapting a standard KNN detector of the ensemble model based on the averaged feature vector.

7. The method according to claim 5, wherein the calculating of the feature vector based on the test or inference data for each of the plurality of artificial neural networks includes:
normalizing the feature vector calculated for each of the plurality of artificial neural networks.

8. The method according to claim 5, wherein each PCA is executed with a predefined number of components, wherein the predefined number of components is selected based on hyperparameters of the plurality of artificial neural networks, and wherein the number of components is smaller than a smallest feature vector of each of the plurality of artificial neural networks.

9. The method according to claim 1, further comprising optimized OOD detection using the KNN method based on the averaged OOD score, and identifying samples in training and/or inference data of an automated function and/or driving function of a motor vehicle and/or a drone and/or a robot which deviate significantly from a training and/or inference distribution in the context.

10. The method according to claim 1, further comprising optimized OOD detection using the KNN method based on the averaged OOD score, and detecting scenarios in training and/or inference data that lead to incorrect predictions by the ensemble model to avoid an occurrence of the scenarios.

11. An apparatus configured to optimize out-of-distribution (OOD) detection using a k-nearest neighbors (KNN) method in an ensemble model with a plurality of artificial neural networks, the apparatus configured to optimize comprising:
an evaluation and computing device which is configured to execute the following steps:
providing an adapted KNN detector for each of the plurality of artificial neural networks;
calculating a respective feature vector based on test or inference data for each of the plurality of artificial neural networks;
providing the calculated feature vector of each of the plurality of artificial neural networks to the adapted KNN detector of the artificial neural network;
ascertaining a respective OOD score for each of the plruality of artificial neural networks using the adapted KNN detector of the artificial neural network based on the feature vector of the artificial neural network; and
averaging the ascertained OOD scores for optimized OOD detection using the KNN method.

12. An apparatus configured to optimize out-of-distribution (OOD) detection using a k-nearest neighbors (KNN) method in an ensemble model with a plurality of artificial neural networks, the apparatus configured to optimize comprising:
an evaluation and computing device configured to execute the following steps:
providing an adapted KNN detector of the ensemble model;
calculating a respective feature vector based on test or inference data for each of the plurality of artificial neural networks;
executing a respective PCA for each of the calculated feature vectors in order to obtain unidimensional feature vectors in each case;
averaging the unidimensional calculated feature vectors to obtain an averaged feature vector; and
calculating an OOD score based on the averaged feature vector by means of the adapted KNN detector.

13. A control device for an automated driving function of a motor vehicle, and/or an automated function of a drone, and/or an automated function of a robot, and/or an automated optical inspection of components and/or samples, wherein the control device is configured to optimize out-of-distribution (OOD) detection using a k-nearest neighbors (KNN) method in an ensemble model with a plurality of artificial neural networks, the control device configured to:
provide an adapted KNN detector for each of the plurality of artificial neural networks;
calculate a feature vector based on test or inference data, for each of the plurality of artificial neural networks;
provide the calculated feature vector of each artificial neural network to the adapted KNN detector of the artificial neural network;
ascertain respective OOD scores using the adapted KNN detector of each artificial neural networked based of the feature vector for the artificial neural network; and
average the ascertained OOD scores for optimized OOD detection using the KNN method.

14. A non-transitory computer-readable data carrier on which is stored program code of a computer program for optimizing out-of-distribution (OOD) detection using a k-nearest neighbors (KNN) method in an ensemble model with a plurality of artificial neural networks, the program code, when executed by a compputer, causing the computer to perform a method for optimizing comprising the following steps:
providing an adapted KNN detector for each of the plurality of artificial neural networks;
calculating a feature vector based on test or inference data, for each of the plurality of artificial neural networks;
providing the calculated feature vector of each artificial neural network to the adapted KNN detector of the artificial neural network;
ascertaining respective OOD scores using the adapted KNN detector of each artificial neural networked based of the feature vector for the artificial neural network; and
averaging the ascertained OOD scores for optimized OOD detection using the KNN method.
